(19) United States
(12) Patent Application Publication
(10) Pub. No.: US 2007/0007885 A1
(43) Pub. Date: Jan. 11, 2007

(54) Full-color organic electroluminescent display device and method for manufacturing the same

(76) Inventors: Chien-Yuan Feng, Chu-Nan (TW); Ting-Chou Chen, Chu-Nan (TW); Hung-Hsin Fu, Chu-Nan (TW); Wen-Jeng Lan, Chu-Nan (TW); Chien-Chin Chiang, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/477,477

(22) Filed: Jun. 30, 2006

(30) Foreign Application Priority Data
Jul. 5, 2005 (TW) 094122932

(51) Int. Cl. H01J 1/62; H01J 9/227

(52) U.S. Cl. 313/504; 430/7; 430/321

(57) ABSTRACT

The present invention relates to a full-color organic electroluminescent display device and a method of manufacturing the same. The device comprises at least one first organic light emitting unit for generating a first color light at a vertical extension place of a first photo-resist of a color filter, and transversely provides at least one fourth organic light emitting unit at vertical extension place of a second photo-resist and third photo-resist of the color filter. A fourth color light is filtered to generate a second color light and a third color light when penetrating the second photo-resist and third photo-resist respectively, thereby mixing and collocating the first color light, second color light, and third color light, such that a full-color light emitting or display function is formed.

### FIELD OF THE INVENTION

The present invention relates to an organic electroluminescent display device, and more particularly to a full-color organic electroluminescent display device and method for manufacturing the same.

### BACKGROUND

In accordance with various displays, it is the key point how to achieve the object of full-color display. For organic electroluminescent display devices (OLED), there are two common ways to achieve full-color function as follows:

1. To provide the organic light emitting elements for generating three primary colors (red, green, and blue) respectively and independently (side by side), such three different colors lights are mixed and collocated with a proper ratio for generating full-color display effect.

However, the organic light emitting element for generating different color light is made by a lot of times evaporation processes, not only manufacturing more complicated, but also evaporation aligning more difficult. Thus, the yield will decrease and cost will increase.

2. To provide at least one organic light emitting element for emitting a white light, such can be collocated with a color filter to show a full-color display effect by filtering color for the white light.

Referring to FIG. 1 for a prior art organic electroluminescent display device 200 with color filtering. The color filter 10 comprises a black matrix 13 provided on a substrate 11 and a color filter layer 15. The color filter layer 15 comprises a first photo-resist (such as a green photo-resist) 151, a second photo-resist (such as a blue photo-resist) 153, and a third photo-resist (such as a red photo-resist) 155 for filtering color. The color filter layer 15 provided on the black matrix 13 and the substrate 11 without providing the black matrix 13. Further, a flat barrier unit 17, such as an overcoat layer or a barrier layer, can be provided on the black matrix 13 and the color filter layer 15 for benefiting to proceed the following processes.

In addition, a first electrode 21 of the organic light emitting element 20 is provided on the flat barrier unit 17. An organic light emitting unit 23 and a second electrode 25 are provided in order on the first electrode 21. When the operating current is provided between the first electrode 21 and the second electrode 22, the organic light emitting unit 23 will emit a white light L. After the white light L passing through the color filter layer 15, it will be filtered and formed into the three primary colors L1, L2, and L3 (red, green, and blue). Therefore, the purpose will be achieved according to mix and collocate the L1, L2, and L3 for the full-color display from the organic electroluminescent display device 200.

By way of the color filter 10 providing, the organic electroluminescent display device 200 only needs an organic light emitting 23 for generating a white light L. Therefore, the times of evaporation processes will be reduced, and the evaporation aligning will be easier. However, according to the widespread wave length of the white light L, it causes the light penetrates through the color filter layer 15 badly, so as to affect the light brightness and the color saturation for the organic electroluminescent display device 200.

### SUMMARY OF THE INVENTION

Accordingly, how to design a novel organic electroluminescent display device and a method for manufacturing the same with respect to the problems encountered by the above mentioned prior art to not only effectively reduce process steps and difficulties in alignment for improving the yields, but also have an effect of improving color light penetration and light color saturation thereof, is the key point of the present invention.

It is a primary object of the present invention to provide a full-color organic electroluminescent display device with reducing the times and difficulty of evaporation processes or masking processes for showing the full-color display effect, such that not only simplifies the process, but also efficiently increases the yield of production.

It is a secondary object of the present invention to provide a full-color organic electroluminescent display device, which is not only used to improve light transmission rate, but also used to enhance the light saturation.

It is another object of the present invention to provide a method for manufacturing a full-color organic electroluminescent display device, which is not only used to simplify the difficulty of alignment and process, but also used to efficiently increase the light transmission and color saturation, and then reduce the power consumption and extend the lifetime of elements.

It is another object of the present invention to provide a full-color organic electroluminescent display device for efficiently reducing the color shift and unsaturated according to the lighting attenuation disproportion of the primary color (R, G, B), and improving light emitting quality.

To achieve the above mentioned objects, the present invention provides a full-color organic electroluminescent display device, comprising a first color filter comprises a first photo-resist, a second photo-resist, and a third photo-resist provided on a substrate; a first electrode provided on the color filter; a first organic light emitting unit provided on the vertical extension place of the first photo-resist for generating a first light; a fourth organic light emitting unit provided on the vertical extension place of the second photo-resist, and the third photo-resist, and provided on said first organic light emitting unit for generating a fourth light; and a second electrode provided on the fourth organic light emitting unit.

Further, to achieve the above mentioned objects, the present invention further provides a method of manufacturing a full-color organic electroluminescent display device, comprising the steps of providing a first photo-resist, a second photo-resist, and a third photo-resist on a substrate to form a first color filter; placing a first mask on the vertical extension place of the second photo-resist and the third photo-resist of the first color filter; aligning with the vertical extension place of the first photo-resist to proceed an evaporation process of a first organic light emitting unit by a first evaporating source to form the first light emitting unit for generating a first color light; and aligning with vertical extension place of the first photo-resist, the second photo-resist and the third photo-resist to proceed an evaporation process of a fourth organic light emitting unit by a fourth evaporating source to form the fourth light emitting unit for generating a fourth color light.

### BRIEF DESCRIPTION OF DRAWINGS

FIG. 1 is a cross sectional view of a prior art organic electroluminescent display device.

FIG. 2 is a cross sectional view of an organic electroluminescent display device one of an embodiment of the present invention.

FIG. 2A is a cross sectional view of another embodiment of the present invention.

FIG. 2B is a cross sectional view of another embodiment of the present invention.

FIG. 2C is a cross sectional view of another embodiment of the present invention.

FIG. 3 is a cross sectional view of another embodiment of the present invention.

FIG. 4 is a cross sectional view of another embodiment of the present invention.

FIG. 5 is a cross sectional view of another embodiment of the present invention.

FIG. 6 is a cross sectional view of an active matrix organic electroluminescent display device of the present invention.

FIG. 7 is a cross sectional view of another embodiment of the active matrix organic electroluminescent display device of the present invention.

FIG. 8 is a cross sectional view of another embodiment of the active matrix organic electroluminescent display device of the present invention.

FIG. 9A and FIG. 9B are respectively cross sectional views of a passive matrix organic electroluminescent display device of the present invention in each process step.

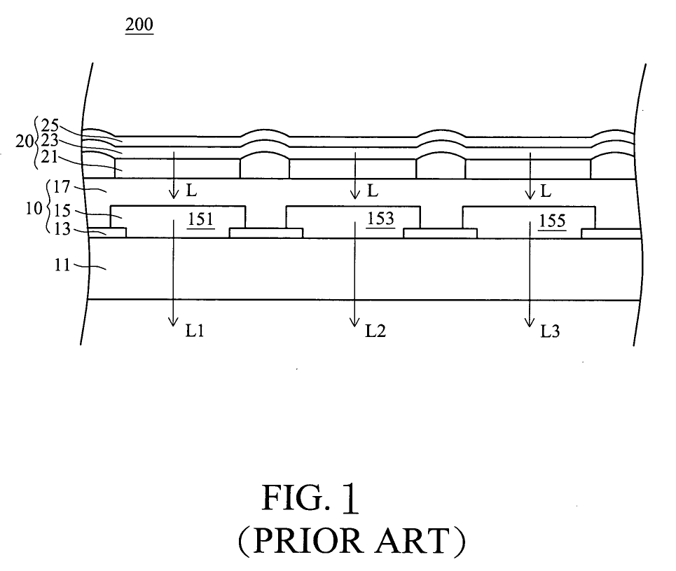

### DETAILED DESCRIPTION

The structural features and the effects to be achieved may further be understood and appreciated by reference to the presently preferred embodiments together with the detailed description.

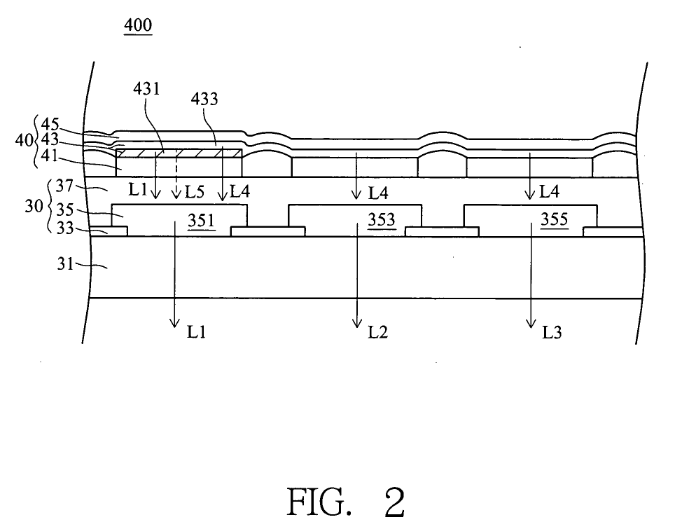

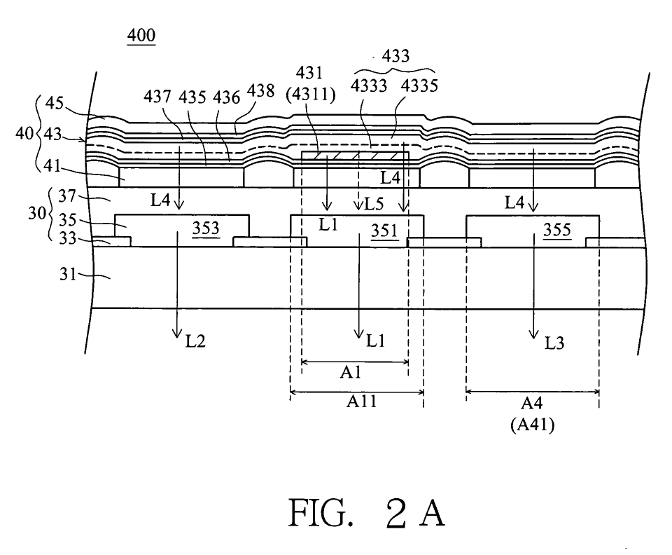

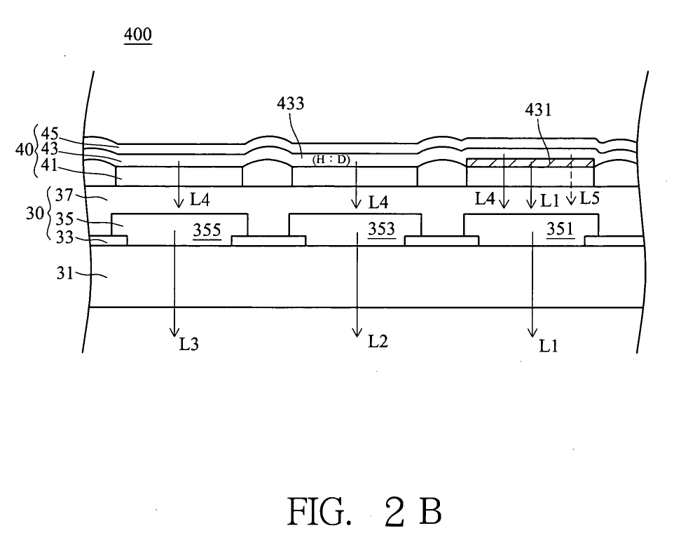

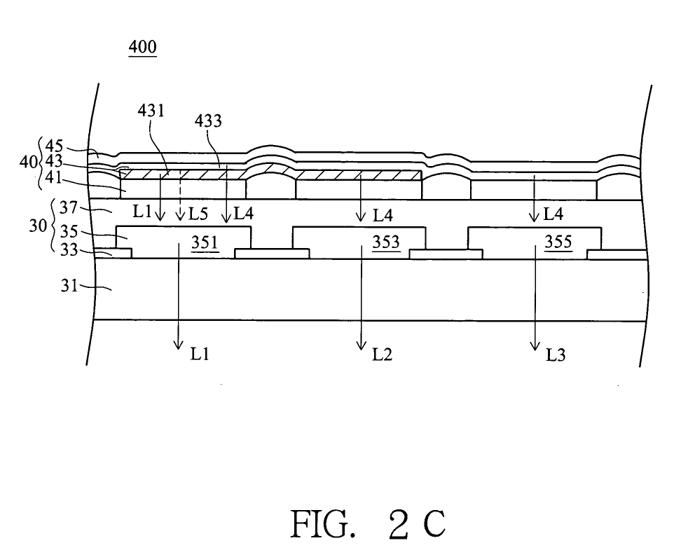

Referring to FIG. 2 for a cross sectional view of one embodiment of the present invention. The organic electroluminescent display device 400 comprises a substrate 31, a first color filter 30, and at least one organic light emitting element 40. The organic light emitting element 40 is provided on a first color filter 30. The first color filter 30 comprises at least one black matrix 33, a color filter layer (or called photo-resist) 35, and a flat battier unit 37. The black matrix 33 is provided on the substrate 31. The color filter layer 35 for color filtering function is provided on the black matrix 33 and the area uncovered black matrix 33 of the substrate 31. The color filter layer 35 comprises a first photo-resist (such as green photo-resist) 351, a second photo-resist (such as blue photo-resist) 353, and a third photo-resist (such as red photo-resist) 355. The flat barrier unit 37, such as an overcoat layer, a barrier layer, or the both, is covered on the black matrix 33 and the color filter layer 35.

A first electrode 41 of the organic light emitting element 40 is provided on the flat barrier unit 37 of the first color filter 30. An organic light emitting unit 43 and a second electrode 45 are provided in order on the first electrode 41. The organic light emitting unit 43 comprises at least one first organic light emitting unit 431 and at least one fourth organic light emitting unit 433. When operating current is supplied between the first electrode 41 and the second electrode 45, the first organic light emitting unit 431 can generate a first light L1, and the fourth organic light emitting unit 433 can generate a fourth light L4.

The first organic light emitting unit 431 is provided on the vertical extension place of the first photo-resist 351 of the first color filter 30. The fourth organic light emitting unit 433 is provided on the vertical extension place of the second photo-resist 353 and the third photo-resist 355 of the first color filter 30, and is provided on the first organic light emitting unit 431. Accordingly, the first light L1 generated by the first organic light emitting unit 431, will pass through the first photo-resist 351, and filtered for generating the first color light L1. The fourth light L4 generated by the fourth organic light emitting unit 433, will respectively pass through the first photo-resist 351, the second photo-resist 353 and the third photo-resist 355, and filtered to generate a first color light L1, a second color light L2, and a third color light L3. By mixing and collocating the first color light L1, the second color light L2, and the third color light L3, the full-color display from the organic electroluminescent display device 400 can be achieved.

Of course, when the first organic light emitting unit 431 and fourth organic light emitting unit 433 are stacked together, the emitting light generated can be a fifth light L5, as shown by a dotted line. The fifth light L5 can be filtered to generate the first color light L1 after passing through the first photo-resist 351.

For example, the first light L1 generated by the first organic light emitting unit 431 is a green light, and the fourth light L4 generated by the fourth organic light emitting unit 433 can be selected by a white light or a complementary light with the first light L1, such as a purple light or a magenta light. Besides, the first photo-resist 351, the second photo-resist 353, and the third photo-resist 355 are respectively as a green photo-resist (351), a blue photo-resist (353), and a red photo-resist (355) or a green photo-resist (351), a red photo-resist (353), and a blue photo-resist (355). Therefore, the first light L1 (green light) will pass through the first photo-resist (green photo-resist) 351 and filtered to generate the first color light L1 (green light) The fourth light L4 (the white light, the purple light or the magenta light) will respectively pass through the first photo-resist 351, the second photo-resist 353 and the third photo-resist 355 and filtered to generate a first color light L1 (green light), a second color light L2 (blue light) and a third color light L3 (red light). By mixing and collocating the first color light L1 (green light), second color light L2 (blue light), and third color light L3 (red light) with a proper ratio, the full-color display from the organic electroluminescent display device 400 can be achieved.

Since the color filter layer 35 only allows specific wavelength field of light passing for filtering the color light. Such as if the first photo-resist 351 is designed for allowing only the wavelength 500 nm˜600 nm to pass through, then the first photo-resist 351 will filter and isolate the light from the wavelength field out of 500 nm˜600 nm, allowing the wavelength 500 nm˜600 nm light to pass, which is a green light as eyeball received, after the light as the white light L passing through the first photo-resist 351. However, when filtering the color light, the wavelength field out of 500 nm˜600 nm, will be filtered and isolated by the first photo-resist 351. Therefore, as far as the white light L is concerned the first photo-resist 351 does not have well penetration for light, which is around 25%; thus, comparatively reducing the light intensity.

On the other hand, if the wavelength of the first light L1 is around the field of allowance wavelength field by the first photo-resist 351, then as far as the first light L1 is concerned the first photo-resist 351 have well transmittance. Such as the wavelength of the first light L1 is around 500 nm˜600 nm (green light). Further, when the wavelength field allowance by the first photo-resist 351 is as foregoing mentioned around 500 nm˜600 nm (green photo-resist), the most first light L1 will be able to pass through the first photo-resist 351 completely. Such as in view of an embodiment of the present invention, the transmittance is up to 80%. Therefore, comparatively the prior art as the organic electroluminescent display device 200 with white light L as the light source, the present invention discloses well light transmittance and intensity, of course, relatively reducing the power consumption and extending the lifetime of element.

By the organic electroluminescent display device 400 of the present invention, the light transmission, light brightness, and light color saturation of the specified color light of the organic electroluminescent display device 400 can be improved. The first organic light emitting unit 431 can be selected according to the usage range and direction of the organic electroluminescent display device 400 to generate different color light. For example, if the organic electroluminescent display device 400 generates the green light usually, the first organic light emitting unit 431 can be selected as an organic light emitting unit for generating the green light. Thus, such not only can improve the light transmission, light brightness, and light color saturation of the green light of the organic electroluminescent display device 400, but also extend the lifetime and reduce the power consumption of the organic electroluminescent display device 400.

Further, the organic light emitting element for generating green light usually has better light emitting efficiency and lifetime. Therefore, when the light emitting efficiency of the first organic light emitting unit 431 is better than the fourth organic light emitting unit 433, such as the organic light emitting unit 431 for emitting green light, the active area of the first organic light emitting unit 431 provided on a single sub pixel can be reduced. For example, the active area A1 of the first organic light emitting unit 431 provided on the single sub pixel can be smaller than the active area A11 of the first photo-resist 351 provided on the same sub pixel. The active area A1 of the first organic light emitting unit 431 provided on the single sub pixel is smaller than the active area A4 of the fourth organic light emitting unit 433 provided on the vertical extension place of the second photo-resist 353 (or the third photo-resist 355) on the different sub pixel. Also, the active area A1 of the first organic light emitting unit 431 provided on the single sub pixel and the active area A11 of the first photo-resist 351 are both smaller than the active area A4 of the fourth organic light emitting unit 433 provided on the different sub pixel and the active area A41 of the second photo-resist 353 and third photo-resist 355. This way, the first organic light emitting unit 431 is allowed to have a larger error range, so as to benefit for processing steps, evaporating and masking, as shown in FIG. 2A.

Of course, in another embodiment of the present invention, the first light L1 generated by the first organic light emitting unit 431 can be a red light or a blue light. The first photo-resist 351 is a red photo-resist or a blue photo-resist. This way, an object of full color display from the organic electroluminescent display device 400 can be achieved.

Besides, since a single pixel of the organic electroluminescent display device 400 comprises a first photo-resist 351, a second photo-resist 353, and a third photo-resist 355. The first photo-resist 351, the second photo-resist 353, and the third photo-resist 355 are all located on a sub pixel of the single pixel individually. The first organic light emitting unit 431 and the first photo-resist 351 are not limited at the position of the sub pixel at two sides of a pixel of the full color organic electroluminescent display device, as shown in the leftmost position in FIG. 2. As well as, that can also be set at the position of the intermediate sub pixel, as shown in FIG. 2A. The first color light L1, the second color light L2, and the third color light L3 can be properly collocated and filtered out. The fourth organic light emitting unit 433, in addition to the above mentioned embodiment as a single layer organic light emitting unit, can be a plural layer stacking organic light emitting unit, which is formed by stacking a plurality of organic light emitting layers 4333 and 4335. A white light or a complementary light L4 can be generated.

The organic light emitting unit 43 set on the vertical extension place of the first photo-resist 351 comprises the first organic light emitting unit 431 and fourth organic light emitting unit 433. The organic light emitting unit 43 can be selected by a hole injection layer 435, a hole transport layer 436, a first organic light emitting layer 4311 of the first organic light emitting unit 431, a second organic light emitting layer 4333 and a third organic light emitting layer 4335 of the fourth organic light emitting unit 433, a electron transport layer 437, and a electron injection layer 438 in order. The second electrode 45 is provided on the electron injection layer 438.

Similarly, the organic light emitting unit 43 set on the vertical extension place of the second photo-resist 353 and the third photo-resist 355 comprises the fourth organic light emitting unit 433. The organic light emitting unit 43 also comprises a hole injection layer 435, a hole transport layer 436, a second organic light emitting layer 4333 and a third organic light emitting layer 4335 of the fourth organic light emitting unit 433, a electron transport layer 437, and a electron injection layer 438 in order. The second electrode 45 is provided on the electron injection layer 438.

Further, the first organic light emitting unit 431 and the first photo-resist 351 can be selectively provided on the position of rightmost (two sides) sub pixel of a pixel of the full color organic electroluminescent display device, as shown in FIG. 2B. Besides, the first organic light emitting unit 431 or fourth organic light emitting unit 433 can be also selected as a dopant type organic light emitting unit with at least one host emitter H doped at least one dopant (guest emitter) D, which is also collocated to generate a white light or a complementary light L4.

In addition to the first organic light emitting unit 431 provided on the vertical extension place of the first photo-resist 351 can also be extended to the vertical extension place of the second photo-resist 353 or the third photo-resist 355. The fourth organic light emitting unit 433 is provided on the first organic light emitting unit 431 and the vertical extension place of the second photo-resist 353 or the third photo-resist 355, as shown in FIG. 2C. This way, it is beneficial for improving the convenience with evaporating, masking, or aligning for the first organic light emitting unit 431.

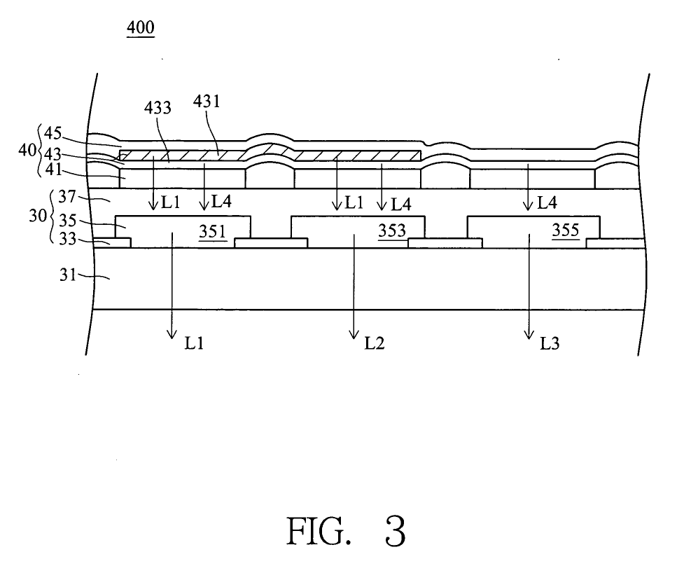

Referring to FIG. 3 for a cross sectional view of another embodiment of the present invention. The first organic light emitting unit 431 can also be extended to the vertical extension place of the second photo-resist 353 from the first photo-resist 351. This way, the difficulty of alignment and evaporation for the organic light emitting layer of the first organic light emitting unit 431 can be reduced without effecting the efficacy of the organic electroluminescent display device 400.

Besides, the provided sequence of the organic light emitting layer of the first organic light emitting unit 431 and the fourth organic light emitting unit 433 can be exchanged. For example, the fourth organic light emitting unit 433 is provided on the first electrode 41 of the vertical extension place of the first photo-resist 351, the second photo-resist 353, and the third photo-resist 355. Then, the organic light emitting layer of the first organic light emitting unit 431 is provided on the fourth organic light emitting unit 433 of the vertical extension place of the first photo-resist 351 and/or the second photo-resist 353. This way, the objects of reducing the difficulty of aligning and evaporating for the organic light emitting layer of the first organic light emitting unit 431, and improving light emitting efficiency and color saturation for the organic electroluminescent display device 400 can also be achieved.

Further, the organic light emitting unit 43, the first organic light emitting unit 431, and the fourth organic light emitting unit 433 are light emitting units, which can generate color light by supplying of the operating current. Therefore, they can be selected by a hole injection layer (HIL), a hole transport layer (HTL), a light emitting layer (EML), an electron transport layer (ETL), an electron injection layer (EIL), and a combination thereof.

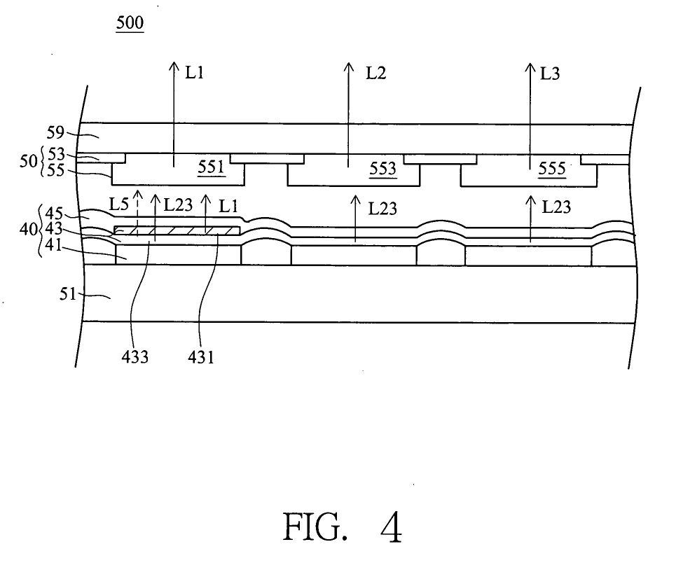

Referring to FIG. 4 for a cross sectional view of another embodiment of the present invention. The organic electroluminescent display device 500 comprises at least one organic light emitting element 40 on a substrate 51. A cap 59 is provided on the substrate 51 to achieve an object of protecting the organic light emitting element 40. A second color filter 50 can be provided on the bottom of the cap 59. The second color filter 50 comprises a black matrix and a color filter layer 55. The color filter layer 55 comprises a first photo-resist 551, a second photo-resist 553, and a third photo-resist 555 with color filtering function. The color filter layer 55 is provided on the black matrix 53 and the cap 59 without providing the black matrix 53.

Further, at least one first electrode 41 is provided on the substrate 51. At least one fourth organic light emitting unit 433 is provided on the first electrode 41. A first organic light emitting unit 431 can be provided on the vertical extension place of the first photo-resist 551. The first organic light unit 431 can be provided on the fourth organic light unit 433. At least one second electrode 45 is provided on the fourth organic light emitting unit 433 and the first organic light emitting unit 431. When the operating current is supplied between the first electrode 41 and the second electrode 45, the first organic light emitting unit 431 and the fourth organic light emitting unit 433 will respectively generate a first light L1 and a fourth light L23. Similarly, the first light L1, the fourth light L23, or the fifth light L5 is filtered to generate the first color light L1 after passing through the first photo-resist 551, and the fourth light L23 is filtered to generate the second color light L2 and the third color light L3 after respectively passing through the second photo-resist 553 and the third photo-resist 555.

In this embodiment, the fourth light L23 is a complementary light with the first light L1. For example, if the first light L1 is a green light, then the fourth light L23 can be a purple light or a magenta light. Further, if the first light L1 is a blue light, then the fourth light L23 can be a yellow light or an orange light. Further, if the first light L1 is a russet light, then the fourth light L23 can be a dark green light.

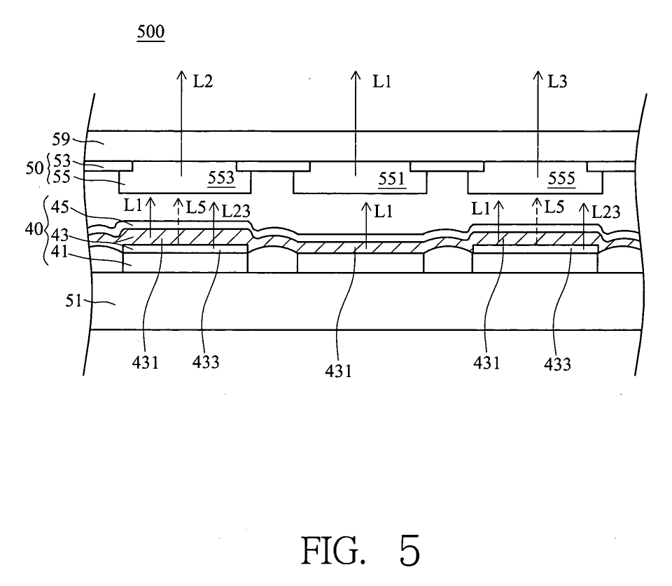

Referring to FIG. 5 for a cross sectional view of another embodiment of the present invention. In comparison with the embodiment as shown in FIG. 3, in this embodiment, the provided sequences and positions of the first organic light emitting unit 431 and fourth organic light emitting unit 433 can be exchanged. For example, the fourth organic light emitting unit 433 is provided on the vertical extension place of the second photo-resist 553 and the third photo-resist 555. The first organic light emitting unit 431 is provided on the vertical extension place of the first photo-resist 551. The first organic light emitting unit 431 is provided on the fourth organic light emitting unit 433. The second photo-resist 553 and the third photo-resist 555, provided in the same pixel, are not closely. The first photo-resist 551 is provided at the intermediate sub pixel of the pixel.

Since the second electrode 45 is made of a material with light transmission and conductibility. With such, the first light L1 and the fourth light L23 can pass through the color filter layer 55 provided on the bottom of the cap 59 to achieve an object of the organic electroluminescent display device 500 with top emission. Wherein, the first light L1 generated by the first organic light emitting unit 431 and the fourth light L23 generated by the fourth organic light emitting unit 433.

Of course, in different embodiments, the substrate 51 can be a transparent substrate made of a light transmission material, and a first color filter 30 is provided on the substrate 51 as shown in the embodiment in FIG. 2. This way, the first light L1, second light L2, the third light L3, the fourth light L23, or the fifth light L5 can pass through the cap 59 and the substrate 51 to be as a double emitting organic electroluminescent display device which can emit light from the top and bottom.

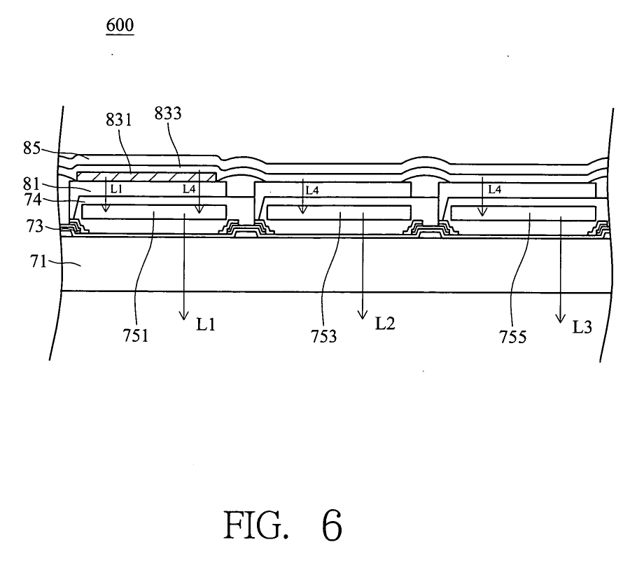

Referring to FIG. 6 for a cross sectional view of another embodiment of the present. The organic electroluminescent display device 600 is an active matrix organic electroluminescent display device. The organic electroluminescent display device 600 comprises at least one thin film transistor (TFT) 73 provided on a substrate 71. The substrate 71 and the thin film transistor 73 are covered by at least one passivation film 74. Wherein, the passivation film 74 provides at least one first photo-resist 751, at least one second photo-resist 753, and at least one third photo-resist 755 therein. Further, at least one first electrode 81 is provided on the passivation film 74. Besides, the first electrode 81 can be respectively electrically connected to the thin film transistor 73.

An organic light emitting layer of the first organic light emitting unit 831 for generating the first light L1 is provided on the first electrode 81 of the vertical extension place of the first photo-resist 751. An organic light emitting layer of the fourth organic light emitting unit 833 for generating the fourth light L4 is provided on the first electrode 81 of the vertical extension place of the second photo-resist 753 and the third photo-resist 755, and on the first organic light emitting unit 831. At least one second electrode 85 is provided on the fourth organic light emitting unit 833. This way, an object of full color display from the active matrix organic electroluminescent display device 600 can be achieved.

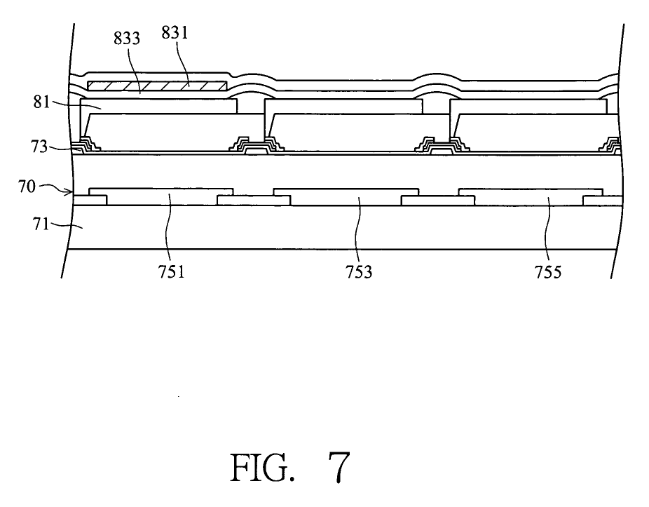

Referring to FIG. 7 for a cross sectional view of another embodiment of the present invention. In comparison with the embodiment shown in FIG. 6, in this embodiment, the first photo-resist 751, the second photo-resist 753, and the third photo-resist 755 can be selectively provided on the substrate 71 to form a color filter 70. The thin film transistor 73 is provided on the color filter 70. Besides, the provided sequences and positions of the first organic light emitting unit 831 and the fourth organic light emitting unit 833 can be exchanged. For example, the fourth organic light emitting unit 833 is provided on the first electrode 81 of the vertical extension place of the first photo-resist 751, the second photo-resist 753, and the third photo-resist 755, and then the first organic light emitting unit 831 is provided on the fourth organic light emitting unit 833 of the vertical extension place of the first photo-resist 751.

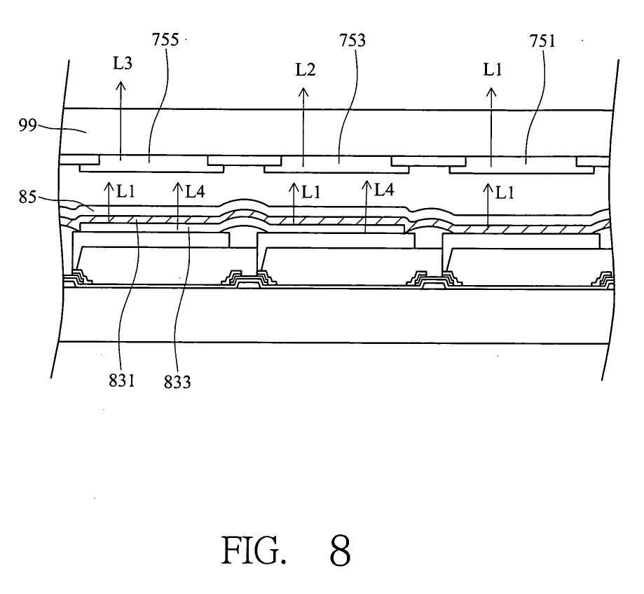

Referring to FIG. 8 for a cross sectional view of another embodiment of the present invention. In comparison with the embodiment shown in FIG. 6, in this embodiment, the first photo-resist 751, the second photo-resist 753, and the third photo-resist 755 can be provided on the bottom of a cap 99. Besides, the second electrode 85 is made of a material with light transmission and conductivity. The first light L1 and the fourth light L4 generated by the first organic light emitting unit 831 and the second organic light emitting unit 833. The first light L1 and the fourth light L4 can pass through the second electrode 85 and the first photo-resist 751, the second photo-resist 753, and the third photo-resist 755 provided on the bottom of the cap 99, and be filtered to generate the first color light L1, the second color light L2, and the third color light L3 to achieve an object of filtering light color. The organic electroluminescent display device comprises at least one thin film transistor provided on a substrate.

Further, the organic light emitting layer of the first organic light emitting unit 831 can across the vertical extension place of the first photo-resist 751, the second photo-resist 753, and the third photo-resist 755. And, the organic light emitting layer of the fourth organic light emitting unit 833 can across the vertical extension place of the second photo-resist 753 and the third photo-resist 755. This way, the difficulty of alignment and evaporation of the first organic light emitting unit 831 can be reduced, and the yield of products can be improved.

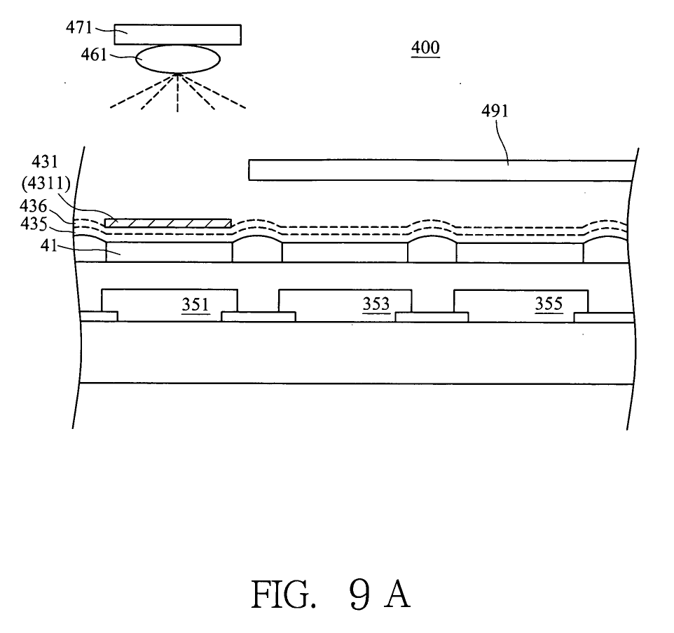

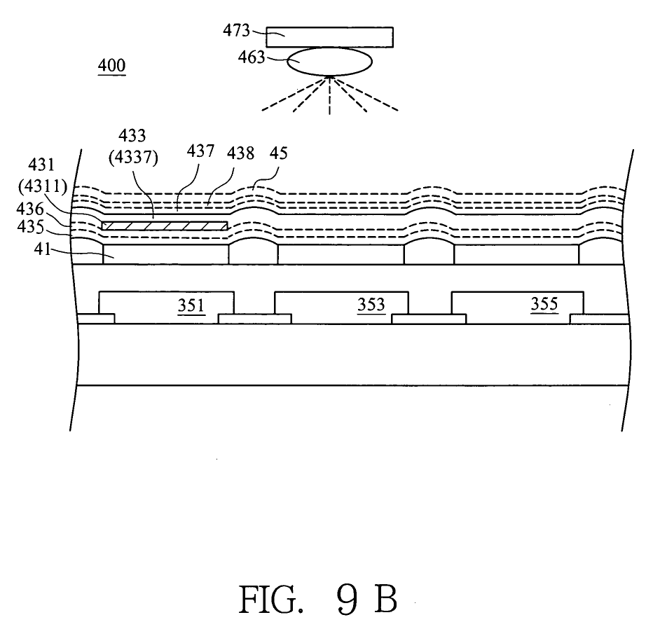

Referring to FIG. 9A and FIG. 9B for cross sectional views of the manufacturing process step of a passive matrix organic electroluminescent display device. As shown, the manufacturing process steps of the organic electroluminescent display device 400 of the present invention, a hole injection layer (HIL) and/or a hole transport layer (HTL) is provided on the first electrode 41 by means of evaporation after providing the first electrode 41 of the organic electroluminescent display device 400. At least one organic light emitting layer of the first organic light emitting unit 431 and at least one organic light emitting layer of the fourth organic light emitting unit 433 are provided on the hole transport layer.

First, a first mask 491 is placed on the vertical extension place of the second photo-resist 353 and the third photo-resist 355. Then, a first evaporating source 471 is used to proceed an evaporation process of the organic light emitting layer of the first organic light emitting unit 431. The organic light emitting layer of the first organic light emitting unit 431 for generating the first light L1 is formed on the first electrode 41 of the vertical extension place of the first photo-resist 351. Wherein, the first evaporating source 471 comprises a first organic light emitting material 461 for generating the first light L1, such as an organic light emitting material can generate a green light, as shown in FIG. 9A.

Of course, in a preferred embodiment of the present invention, before evaporating the organic light emitting layer 4311 of the first organic light emitting unit 431, a hole injection layer 435 and/or hole transport layer 436 is formed on the first electrode 41, as shown by the dotted line. Later, the organic light emitting layer 4311 of the first organic light emitting unit 431 is formed on the hole injection layer 435 and/or the hole transport layer 436.

Next, a fourth evaporating source 473 is used to proceed an evaporation process of the organic light emitting layer of the fourth organic light emitting unit 433. The fourth evaporating source 473 forms the fourth organic light emitting unit 433 on the vertical extension place of the first photo-resist 351, the second photo-resist 353, and the third photo-resist 355 by evaporation process. At least one fourth organic light emitting layer 4337 of the fourth organic light emitting unit 433 for generating the fourth light L4 is formed on the first electrode 41 (or the hole transport layer) and the first organic light emitting unit 431 (or the first organic light emitting layer 4311). The fourth evaporating source 473 comprises a fourth organic light emitting material 463 for generating the fourth light L4, such as an organic light emitting material can generate a white light, a purple light, or a magenta light, as shown in FIG. 9B.

In another embodiment of the present invention, the evaporation of the organic light emitting layer of the fourth organic light emitting unit 433 can be proceeded first. Then, the first mask 491 is placed on the vertical extension place of the second photo-resist 353 and the third photo-resist 355. The organic light emitting layer of the first organic light emitting unit 431 is formed on the fourth organic light emitting unit 433 (without covering by the first mask 491) of the vertical extension place of the first photo-resist 351.

After finishing providing the organic light emitting layer of the first organic light emitting unit 431 and the fourth organic light emitting unit 433, the follow-up process of the organic electroluminescent display device 400 can be proceeded. For example, the electron transport layer 437 and/or electron injection layer 438 and/or second electrode 45 is formed in order on the organic light emitting layer 4337 of the fourth organic light emitting unit 433 by means of evaporation, as shown by the dotted line, so as to finish the organic electroluminescent display device 400 provided.

In comparison with prior art independently providing organic electroluminescent elements of primitive color (red, green, and blue), the difficulty and times of evaporation, masking, and aligning of organic light emitting unit 43 can be reduced for forming the full color organic electroluminescent display device. Further, by reducing times of evaporation, the yield of the organic electroluminescent display device 400 can be improved.

Of course, the above mentioned process steps can be suitable in active matrix organic electroluminescent display devices. The first organic light emitting unit 831 and the fourth organic light emitting unit 833 can also be formed by the same way.

The foregoing description is merely one embodiment of present invention and not considered as restrictive. All equivalent variations and modifications in process, method, feature, and spirit in accordance with the appended claims may be made without in any way from the scope of the invention.

1. A full-color organic electroluminescent display device, comprising:
a substrate;
a first color filter comprising a first photo-resist, a second photo-resist, and a third photo-resist provided on said substrate;
a first electrode provided on said first color filter;
a first organic light emitting unit provided on the vertical extension place of said first photo-resist for generating a first light;
a fourth organic light emitting unit provided on the vertical extension place of said second photo-resist, and said third photo-resist, and provided on said first organic light emitting unit for generating a fourth light; and
a second electrode provided on said fourth organic light emitting unit.

2. The display device of claim 1, wherein said first organic light emitting unit is provided on the vertical extension place of said first photo-resist and said second photo-resist.

3. The display device of claim 1, wherein the sequence of said first organic light emitting unit and said second organic light emitting unit can be exchanged.

4. The display device of claim 1, further comprising a cap provided on said substrate, and a first photo-resist, a second photo-resist, and a third photo-resist.

5. The display device of claim 1, wherein said first color filter comprises at least one thin film transistor.

6. The display device of claim 1, wherein the light emitting efficiency of said first organic light emitting unit is better than said fourth organic light emitting unit.

7. The display device of claim 6, wherein the active area of said first organic light emitting unit on a single sub pixel is smaller than the active area of said fourth organic light emitting unit on a different sub pixel.

8. The display device of claim 1, wherein said fourth organic light emitting unit is selected as one of a single layer organic light emitting unit, a plural layer stacking organic emitting unit, and a dopant type organic light emitting unit.

9. The display device of claim 1, wherein said first organic light emitting unit and said fourth organic light emitting unit are respectively selected as one of a hole injection layer, a hole transport layer, an organic light emitting layer, an electron transport layer, an electron injection layer, and a combination thereof.

10. The display device of claim 1, wherein said fourth light is selected as one of a white light and a light complemented said first light.

11. The display device of claim 1, further comprising a cap provided on said substrate, a second color filter can be provided on the bottom of said cap.

12. The display device of claim 1, further comprising a flat barrier unit on said first color filter.

13. The display device of claim 1, further comprising at least one thin film transistor on said substrate, said substrate and said thin film transistor are covered by at least one passivation film.

14. A full-color organic electroluminescent display device, comprising:
a substrate;
a first electrode provided on said substrate;
a first organic light emitting unit provided on said first electrode;
a fourth organic light emitting unit provided on said first electrode and said first electrode;
a second electrode provided on said fourth organic light emitting unit; and
a cap provided on said substrate, a second color filter can be provided on the bottom of said cap;
wherein said first organic light emitting unit is provided on the vertical extension place of a first photo-resist of said second color filter, and said fourth organic light emitting unit is provided on the vertical extension place of said second color filter.

15. The display device of claim 14, wherein said first light emitting unit is provided on the vertical extension place of said first photo-resist and a second photo-resist of said second color filter.

16. The display device of claim 14, further comprising at least one thin film transistor on said substrate.

17. A method of manufacturing a full-color organic electroluminescent display device, comprising the steps of:
providing a first photo-resist, a second photo-resist, and a third photo-resist on a substrate to form a first color filter;
placing a first mask on the vertical extension place of said second photo-resist and said third photo-resist of said first color filter;
aligning with the vertical extension place of said first photo-resist to proceed an evaporation process of a first organic light emitting unit by a first evaporating source to form said first light emitting unit for generating a first color light; and
aligning with vertical extension place of said first photo-resist, said second photo-resist and said third photo-resist to proceed an evaporation process of a fourth organic light emitting unit by a fourth evaporating source to form said fourth light emitting unit for generating a fourth color light.

18. The manufacturing method of claim 17, further comprising the steps of:
forming a first electrode on said first color filter; and
forming a hole injection layer or a hole transport layer on said first electrode;
wherein said first light emitting unit on said hole injection layer or said hole transport layer.

19. The manufacturing method of claim 17, further comprising the steps of:
forming a hole electron transport layer or an electron injection layer on said fourth light emitting unit; and
forming a second electrode on said hole electron transport layer or said electron injection layer.

20. A method of manufacturing a full-color organic electroluminescent display device, comprising the steps of:
providing a first photo-resist, a second photo-resist, and a third photo-resist on a substrate to form a first color filter;
aligning with vertical extension place of said first photo-resist, said second photo-resist and said third photo-resist to proceed an evaporation process of a fourth organic light emitting unit by a fourth evaporating source to form said fourth light emitting unit for generating a fourth color light;
placing a first mask on the vertical extension place of said second photo-resist and said third photo-resist of said first color filter; and
aligning with the vertical extension place of said first photo-resist to proceed an evaporation process of a first organic light emitting unit by a first evaporating source to form said first light emitting unit for generating a first color light.

21. The manufacturing method of claim 20, further comprising the steps of:
forming a first electrode on said first color filter; and
forming a hole injection layer or a hole transport layer on said first electrode;
wherein said fourth light emitting unit on said hole injection layer or said hole transport layer.

22. The manufacturing method of claim 20, further comprising the steps of:
forming a hole electron transport layer on said first light emitting unit and said fourth light emitting unit; and
forming a second electrode on said hole electron transport layer.
